(19) United States
(12) Patent Application Publication
(10) Pub. No.: US 2003/0067642 A1
(43) Pub. Date: Apr. 10, 2003

(54) Ringing and inter-symbol interference reduction in optical communications

(76) Inventors: Lars-Gote Svenson, Sollentuna (SE); Edgard Goobar, Stockholm (SE); Krister Frojdh, Alvsjo (SE)

Correspondence Address: J. D. Harriman II, COUDERT BROTHERS LLP, 23rd Floor, 333 South Hope Street, Los Angeles, CA, 90071, US

(21) Appl. No.: 09/974,718

(22) Filed: Oct. 9, 2001

(51) Int. Cl. H04K 3/00; H04B 10/12

(52) U.S. Cl. 359/111; 359/173

(57) ABSTRACT

Embodiments of the present invention provide for ringing and inter-symbol interference reduction in optical communications. In one embodiment of the present invention, the rise time of the signal is longer than the fall time of the signal. The resulting asymmetrical driver pulse is sent to the laser. The resulting overshoot, ringing, undershoot and chirp of the output from the laser are greatly reduced. As a result, the eye is approximately symmetrical and is less closed.

### BACKGROUND OF THE INVENTION

1. Field of the Invention

The present invention relates to the field of optical communications, and in particular to a method and apparatus for inter-symbol interference reduction in optical communications.

2. Background Art

Communications systems operate by sending a signal from a sender to a receiver. Generally this signal is an electrical signal but some optical based communications systems use light instead of electricity. Data is sent as a series of light pulses that may be produced by a laser and sent on an optical fiber or even through the air. One way that optical communications systems send a light signal is by directly modulating the current supplied to the laser. The changing current causes the intensity of the laser beam to vary, resulting in light pulses.

A number of problems can occur in high-speed modulation of optical components such as direct modulated laser diodes. In a typical output for a direct modulated laser, there is an overshoot followed by an undershoot for transitions from low to high. Similarly, there is an undershoot for transitions from high to low. This phenomenon is called “ringing,” and the ringing effect from a transition decreases over time. As a consequence of the undershoot the high level of the laser is decreased for a certain period of time, which increases the risk for transmission errors at the receiver. Further, if the ringing effect persists over a time frame larger than a single bit slot it may even interfere with the signals of the following slots.

The phenomenon of previous bit slots contributing to the amplitude of a signal is termed “inter-symbol interference.” Inter-symbol interference causes negative effects such as increased bit-error rates at the receiver. When the pulse rates are relatively slow (e.g. millions of bits per second, or megabits), the ringing can be tolerated since it only occupies a very small portion of a single bit slot. But when the pulse rate is higher (e.g. billions of bits per second, or gigabits), the ringing prevents the accurate transmission of information and data.

The ringing frequency is dependent of the relaxation frequency of the lasers. However, due to the non-linear characteristics, the relaxation frequency will vary with the pulse amplitude, and cannot be removed by filtering. For example, in a typical output for a direct modulated laser, the oscillation of the ringing at the lower level is much slower than at the upper level.

Another problem with current methods of laser modulation is frequency modulation of the light output, termed “chirp.” The chirp generates a pulse shape distortion as the signal is transmitted through a fiber with non-zero group velocity dispersion. The pulse shape distortion increases the power necessary at the receiver for sufficiently error free detection. The need for the increase in power is called dispersion penalty.

Prior art method of generating laser pulses, referred to as “direct modulation” lead to ringing, inter-symbol interference and chirp in optical communications resulting in a loss of performance. This problem can be better understood by a review of direct modulated laser signals.

Direct Modulated Laser Signals

In prior art optical systems, lasers are directly and symmetrically modulated to produce a signal by increasing and decreasing the current to the laser. An increase and decrease pair is termed a “pulse.” The pulse width of a symmetric input signal is equal to the bit-period. FIG. 1 shows a typical optical communication system. A digital bit stream 110 is sent to a pulse shaper and driver circuit 120 driving a direct modulated laser diode 130. The generated light is coupled into an optical fiber 140. At the other end of the fiber, the light is detected by a detector 150. The current from the detector is amplified and filtered and finally made digital by the receiver electronics 160 which transmit a digital stream 170 which should be identical to the incoming bit stream 110.

FIG. 2 illustrates a symmetric driver pulse. One pulse 200 is initiated at −100 ps, and the current rises to 50 mA at time −50 ps. Then, the pulse is terminated at time 0 and the current falls to the low level of 20 mA at time 50 ps. Another pulse 250 is out of phase with the pulse 200 by 100 ps. The area out of phase 240, is termed the “eye-opening,” and the entire diagram where the pulse shapes overlap is termed an “eye-diagram.” The eye-opening of the driver pulse is symmetrical. However, the output from a laser resulting from the symmetric driver pulse of FIG. 2 exhibits ringing and chirping.

FIG. 3 illustrates a laser output given the symmetric driver pulse of FIG. 2. The output contains an overshoot 300 and a ringing undershoot 310 from the high level after the rise in current from the driver pulse. Additionally, the output contains an undershoot 320 of the low level following the fall in current from the driver pulse. The resulting eye 330 is asymmetrical and partly closed due to the ringing. In this particular example, there is a ringing effect when a preceding pulse is a zero resulting in a type of inter-symbol interference. Additionally, a receiver attempting to detect the transmitted signal may misdetect the signal due to the undershoot. This results in errors in data transmission.

FIG. 4 illustrates the chirp resulting form the driver pulse of FIG. 2. The peak-to-peak value (the difference between the value at the high peak and the value at the low peak) is approximately 17 units.

Low-Pass Filtering

One prior art method of preventing ringing and inter-symbol interference is to low-pass filter the driving current. Thus, any signal power that would have been amplified by the peak in frequency response of the laser is avoided, hopefully reducing ringing. However, if the bitrate is close to the relaxation oscillation frequency, this method results in a loss of performance. FIG. 5 illustrates a low-pass filtered symmetric driver pulse. FIG. 6 illustrates the laser output given the symmetric driver pulse of FIG. 5. The overshoot 600, ringing 610, and undershoot 620 are all reduced. However, the eye 630 is still asymmetrical and partially closed. FIG. 7A illustrates the chirp resulting form the driver pulse of FIG. 5. The chirp is reduced (having a peak-to-peak value of approximately 15 units), but still significant.

Pulse Propagation Over Single Mode Optical Fiber

FIG. 7B illustrates pulse propagation over single mode optical fiber. The transmission speed is 10 Gbit/s. In pane 1 700, a symmetrical pulse is generated. Each pulse has a pulseshape with a linear slope for both the rising and falling edge. Both the rise and fall time are 20 ps. The pulses are used to drive a laser and the resulting signal is in pane 2 710. Pane 3 720 shows the signals after they have propagated over a single mode optical fiber 40 km in length. At the end of the fiber, the signal reaches a receiver. The receiver is modeled as a PIN-diode receiver with a 7.5 GHz 4^{th} order Bessel filter. Pane 4 730 shows the filtered signal.

### SUMMARY OF THE INVENTION

Embodiments of the present invention provide for ringing and inter-symbol interference reduction in optical communications. In one embodiment of the present invention, the rise time of the signal is longer than the fall time of the signal. The resulting asymmetrical driver pulse is sent to the laser. The resulting overshoot, ringing, undershoot and chirp of the output from the laser are greatly reduced. As a result, the eye is approximately symmetrical and is less closed.

### BRIEF DESCRIPTION OF THE DRAWINGS

These and other features, aspects and advantages of the present invention will become better understood with regard to the following description, appended claims and accompanying drawings where:

FIG. 1 is a block diagram of a typical optical communication system.

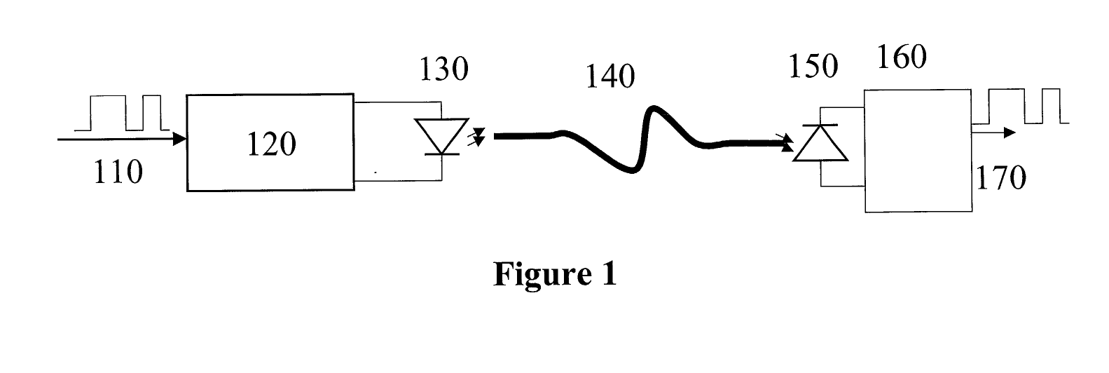

FIG. 2 is an eye diagram of a symmetric driver pulse.

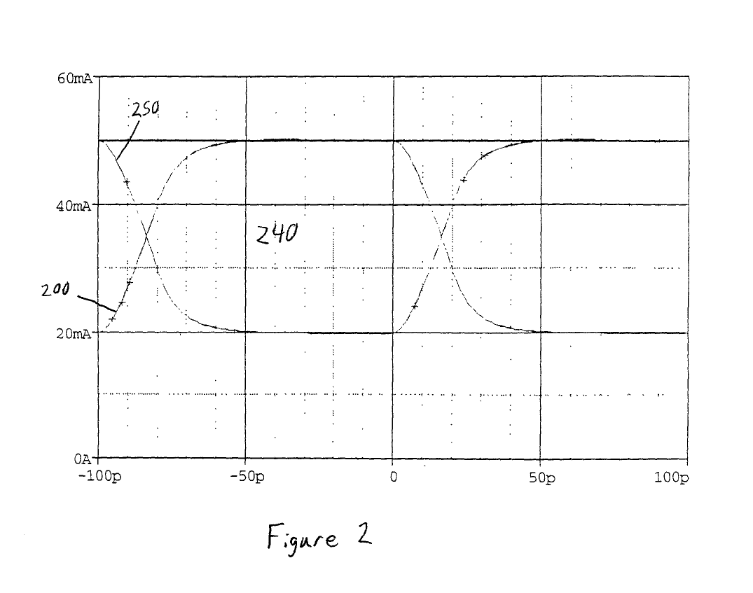

FIG. 3 is an eye diagram of the laser output given the symmetric driver pulse of FIG. 2.

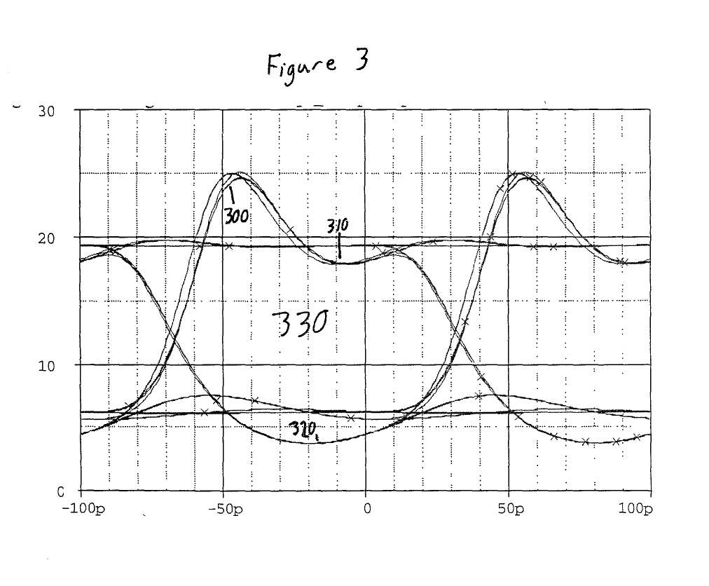

FIG. 4 is a graph of the chirp resulting from the driver pulse of FIG. 2.

FIG. 5 is an eye diagram of a low-pass filtered symmetric driver pulse.

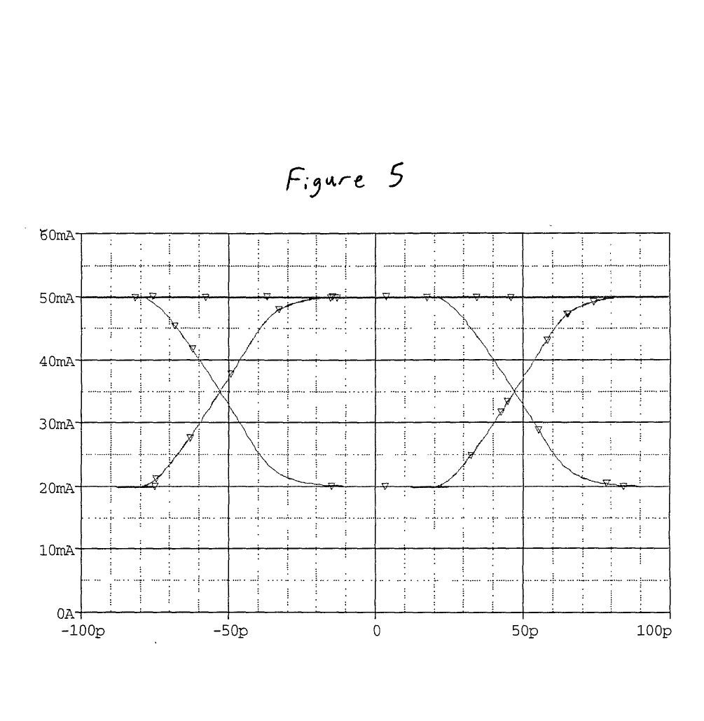

FIG. 6 is an eye diagram of the laser output given the symmetric driver pulse of FIG. 5.

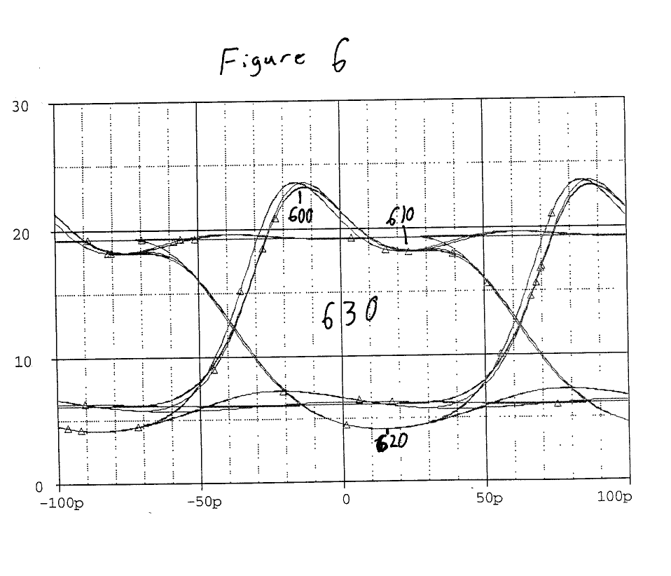

FIG. 7A is a graph of the chirp resulting from the driver pulse of FIG. 5.

FIG. 7B is an eye diagram of pulse propagation over single mode optical fiber.

FIG. 8A is a graph illustrating rise time and fall time in accordance with one embodiment of the present invention.

FIG. 8B is a block diagram of pulse shaper in accordance with one embodiment of the present invention.

FIG. 8C is a flow diagram of the process of shaping a driver pulse in accordance with one embodiment of the present invention.

FIG. 9 is a block diagram of a duty cycle distorter in accordance with one embodiment of the present invention.

FIG. 10 is a graph of signals in a duty cycle distorter in accordance with one embodiment of the present invention.

FIG. 11 is a graph of signals in a duty cycle distorter in accordance with one embodiment of the present invention.

FIG. 12 is a block diagram of a series of duty cycle distorters configured to increase pulse width and rise time in accordance with one embodiment of the present invention.

FIG. 13 is an eye diagram of the input and output signals for a summation unit in a series of duty cycle distorters in accordance with one embodiment of the present invention.

FIG. 14 is a block diagram of a summing amplifier with five inputs in accordance with one embodiment of the present invention.

FIG. 15 is an eye diagram of an asymmetric driver pulse in accordance with one embodiment of the present invention.

FIG. 16 is an eye diagram of the laser output given the asymmetric driver pulse of FIG. 15 in accordance with one embodiment of the present invention.

FIG. 17 is a graph of the chirp resulting from the driver pulse of FIG. 15 in accordance with one embodiment of the present invention.

FIG. 18 is an eye diagram of pulse propagation over single mode optical fiber in accordance with one embodiment of the present invention.

FIG. 19 is a graph of bit-error showing the error associated with symmetric driver pulses and asymmetric driver pulses in accordance with one embodiment of the present invention.

FIG. 20 is a set of graphs of a symmetric pulse driver output, transmitter output, received signal and filtered signal.

FIG. 21 is a set of graphs of an asymmetric pulse driver output, transmitter output, received signal and filtered signal in accordance with one embodiment of the present invention.

FIG. 22 is a graph of sensitivity contours in accordance with one embodiment of the present invention.

### DETAILED DESCRIPTION OF THE INVENTION

Embodiments of the present invention provide for ringing and inter-symbol interference reduction in optical communications. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

In one embodiment of the present invention, the rise time of the signal is longer than the fall time of the signal. The resulting asymmetrical driver pulse is sent to the laser. The resulting overshoot, ringing, undershoot and chirp of the output from the laser are greatly reduced, resulting in better receiver sensitivity. The eye of the signal is approximately symmetrical and is less closed.

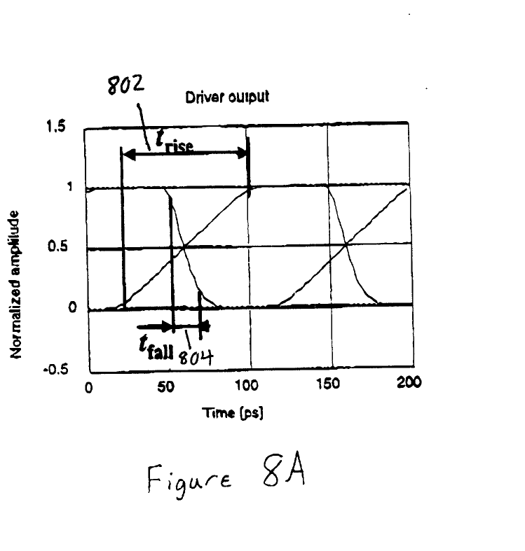

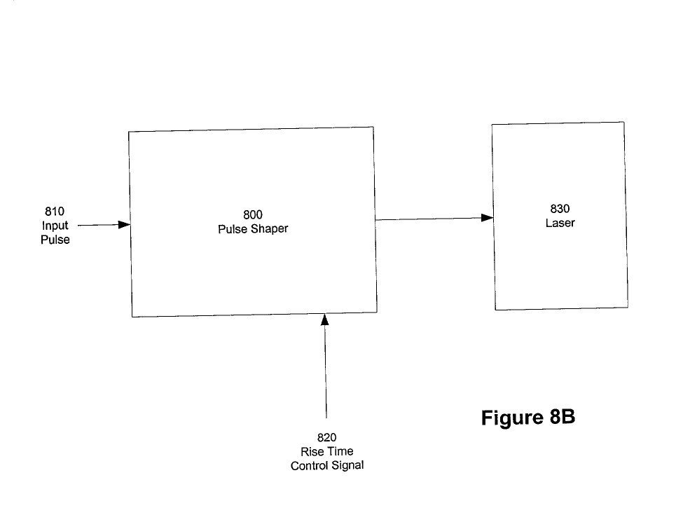

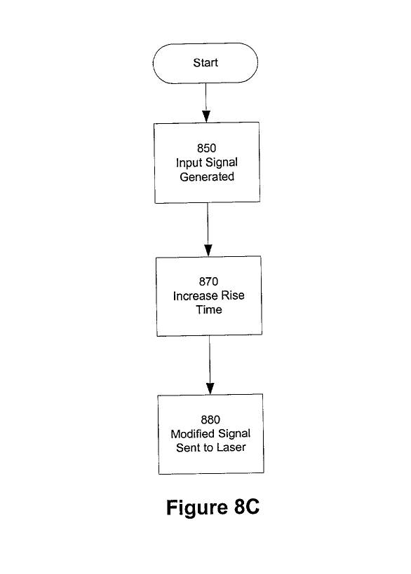

FIG. 8A illustrates a driver output where the rise time is longer than the fall time. The rise time 802 is the distance in time between when the pulse is initiated at 0 and when the pulse rises to its high value of 1. The fall time 804 is the distance in time between when the pulse begins to fall from its high value of 1 and when it reaches its low value of 0.

In various embodiment, the rise time is at least 50% longer than the fall time. In other embodiments, the rise time is at least twice the fall time. In still other embodiments, the rise time is at least 30% of the bit-period.

FIG. 8B illustrates the use of a pulse shaper in a transmitter in accordance with the present invention. A pulse shaper 800 connects to a rise time control signal 820. An input pulse 810 is provided to the pulse shaper. The rise time control signal is used to increase the rise time of the incoming pulses. Once the pulse rise time is adjusted, the signal is sent to a laser 830.

FIG. 8C illustrates the process of shaping a driver pulse in accordance with one embodiment of the present invention. At step 850, the input signal is generated. At step 870, the rise time of each pulse in the signal is increased. At step 880, the modified signal is sent to the laser.

Duty Cycle Distorter

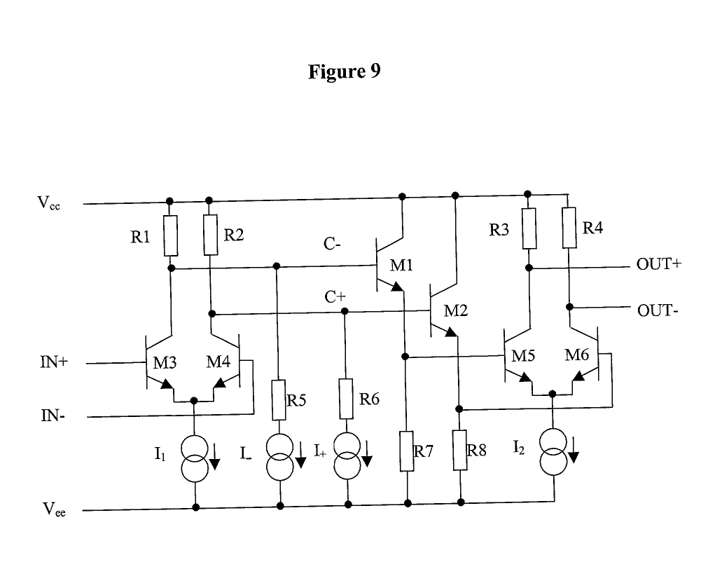

In one embodiment, a series of duty cycle distorters are used to increase pulse rise time. FIG. 9 illustrates a duty cycle distorter in accordance with one embodiment of the present invention. The positive supply voltage, V_{cc}, couples to resistor R1, resistor R2, resistor R3, resistor R4, the collector of transistor M1 and the collector of transistor M2. Resistor R1 couples to the base of transistor M1, the collector of transistor M3 and resistor R5. Resistor R2 couples to the base of transistor M2, the collector of transistor M4 and resistor R6.

The emitter of transistor M1 couples to resistor R7 and the base of transistor M5. The emitter of transistor M2 coupled to resistor R8 and the base of transistor M6. Resistor R3 couples to signal OUT+0 and the collector of transistor M5. Resistor R4 couples to signal OUT− and the collector of transistor M6. The IN+ signal couples to the base of transistor M3. The IN− signal couples to the base of transistor M4.

The negative supply voltage, Vₑₑ, couples to current generator I₁, current generator L, current generator I₊, current generator I₂, resistor R7 and resistor R8. Current generator I₁ couples to the emitters of transistor M3 and transistor M4. Current generator L couples to resistor R5. Current generator I₊ couples to resistor R6, and current generator I₂ coupled to the emitters of transistor M5 and transistor M6.

In one embodiment, the output duty cycle is adjusted by altering current generator I₊ or current generator L. In one embodiment, either the current from current generator I₊ or the current from current generator I is 0. The voltage where the collector of transistor M3 couples to transistor M1 is C−. Similarly, the voltage where the collector of transistor M4 couples to transistor M2 is C+.

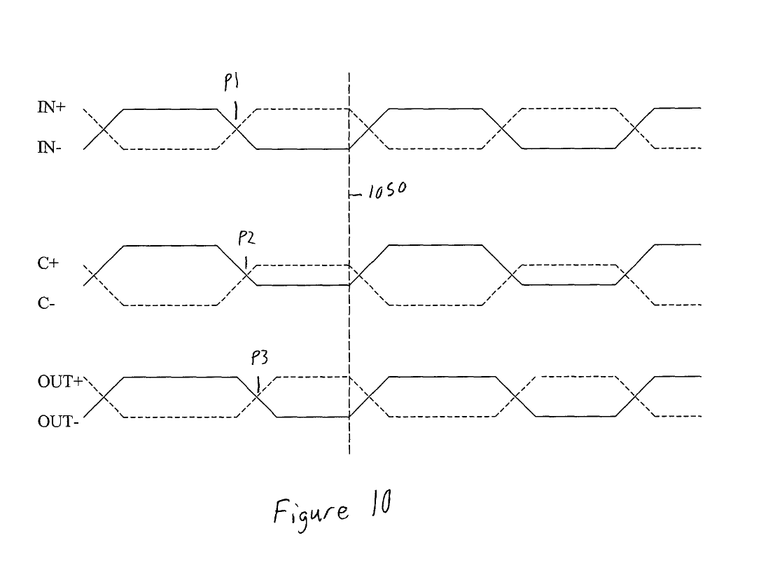

FIG. 10 illustrates signals in a duty cycle distorter in accordance with one embodiment of the present invention. Signal IN+ and signal IN− form a symmetric input signal to the duty cycle distorter. The IN+ signal crosses the IN− signal at crossing over point P1. However, signals IN+ and IN− still have the same high and low values.

The current from current generator I₊ is greater than the current from current generator L. As a result, the mean voltage of C+ falls below the mean voltage of C−. The low values for C+ are lower than the low values for C−, and the high values for C+ are lower than the high values of C−. As a result, signal C+ crosses the C− signal at crossing over point P2. Crossing over point P2 occurs later that crossing over point P1.

Signals OUT+ and OUT− are the output of the limiting amplifier of the duty cycle distorter. The positive pulse width of OUT+ is decreased and the positive pulse width of OUT− is increased. OUT+ crosses OUT− at crossing over point P3. A delay in the limiting amplifier causes crossing over point P3 to occur later than crossing over point P2. Increasing I₂ reduces the delay of the limiting amplifier. Similarly, increasing I₊ causes crossing over point P2 to occur later and results in a shorter positive pulse width for both C+ and OUT+. The end line 1050 indicates that the signals of IN+, C+ and OUT+ all terminate at the same time. The end line does not move as a result of altering I₂ or I₊.

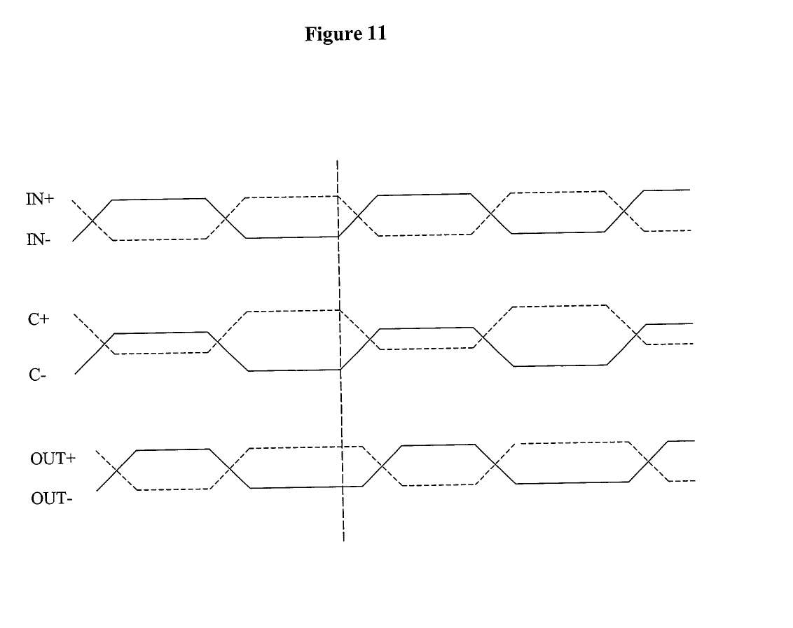

FIG. 11 illustrates signals of a duty cycle distorter in accordance with one embodiment of the present invention. The signals used for IN+ and IN− are identical to the signals for IN+ and IN− in FIG. 10. However, the current from current generator I₊ is less than the current from current generator L. As a result, the mean voltage of C+ rises above the mean voltage of C−. The low values for C+ are higher than the low values for C−, and the high values for C+ are higher than the high values of C−. Signals OUT+ and OUT− are the output of the limiting amplifier of the duty cycle distorter. The positive pulse width of OUT+ is increased and the positive pulse width of OUT− is decreased.

Series of Duty Cycle Distorters

In one embodiment, a series of duty cycle distorters, DCDs, is used to increase the pulse rise time. In one embodiment, the pulse width is not increased using DCDs. In other embodiments, the pulse width is increased using one or more DCDs. Regardless of whether the initial pulse width if increased, the pulse width is decreased by a series of DCDs. The result of each successive decreasing by a decreasing DCD is summed with the increased pulse width from the increasing DCD. The sum is the output signal of the series of DCDs. The output signal has an increased pulse rise time.

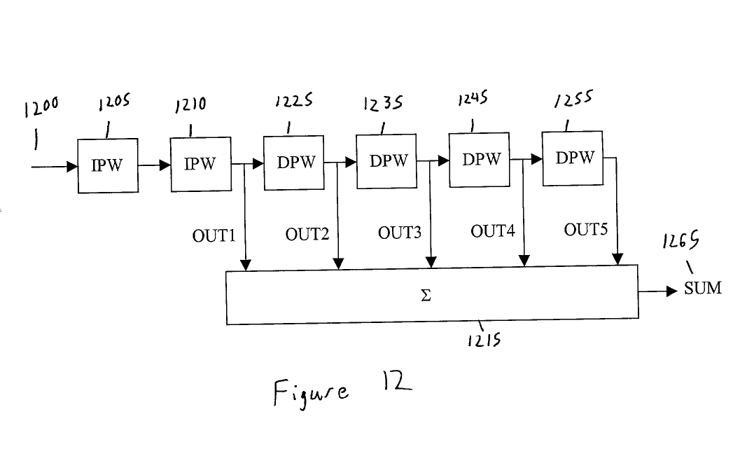

FIG. 12 illustrates a series of duty cycle distorters configured to increase pulse rise time in accordance with one embodiment of the present invention. A signal 1200 is the input to DCD 1205. The output of DCD 1205 is the input for DCD 1210. Both DCD 1205 and DCD 1210 are increasing pulse width (IPW) DCDs. Thus, the original input signal has a longer pulse width due after being output from DCD 1210.

The output from DCD 1210 is an input to the summation unit 1215 as OUT1. The output from DCD 1210 is also the input to DCD 1225. Similarly, the output from DCD 1225 is an input to the summation unit as OUT2. The output from DCD 1225 is also the input to DCD 1235. Likewise, the output from DCD 1235 is an input to the summation unit as OUT3. The output from DCD 1235 is also the input to DCD 1245.

Finally, the output from DCD 1245 is an input to the summation unit as OUT4. The output from DCD 1245 is also the input to DCD 1255. Also, the output from DCD 1255 is an input to the summation unit as OUT5. DCD 1225, DCD 1235, DCD 1245 and DCD 1255 are decreasing pulse width (DPW) DCDs. Thus, the pulse width of the signal is gradually decreased as it passes through successive DWP DCDs.

The termination time of the pulse is the same in the output signals of DCD 1210, DCD 1225, DCD 1235, DCD 1245 and DCD 1255. Thus, the fall time of the sum of the signals 1265 is identical to the fall times of OUT1, OUT2, OUT3, OUT4 and OUT5. However, the pulse width gets progressively shorter as the signal passes through the series of DCDs. as a result, the initiation and completion of the rise of the signal occurs later and later with successive DCDs in the series. Thus, the sum of the signals has a rise time that is longer than the fall time. The rise time of the signal from the summation unit begins when the rise in OUT1 begins and ends when the rise in OUT5 ends.

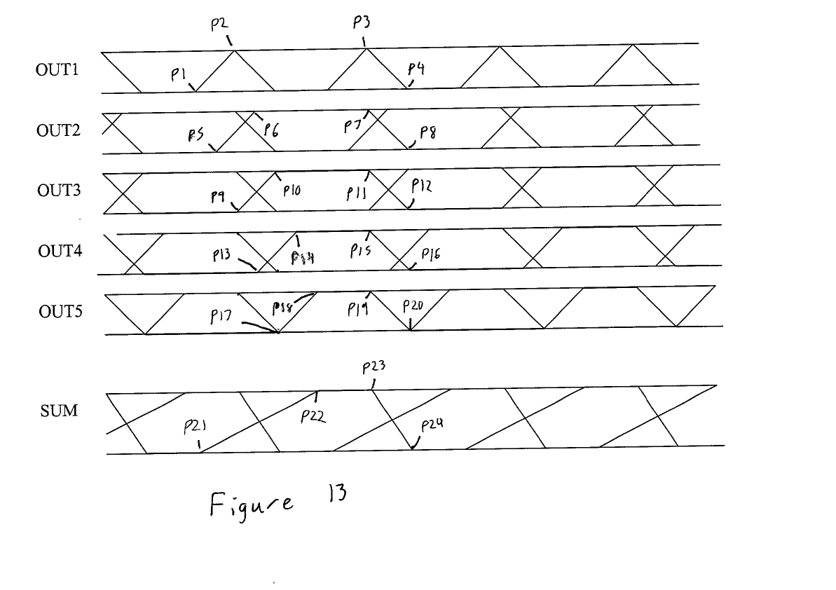

FIG. 13 illustrates the input and output signals for a summation unit in a series of duty cycle distorters in accordance with one embodiment of the present invention. The rise of a pulse in signal OUTI begins at point P1. The rise ends at point P2. The fall of the pulse begins at point P3 and ends at point P4. Similarly, the rise of a pulse in signal OUT2 begins at point P5 and ends at point P6. Point P5 occurs later than point P1, and point P6 occurs later than point P2. The fall of the pulse begins at point P7 and ends at point P8.

The rise of a pulse in signal OUT3 begins at point P9 and ends at point P10. Point P9 occurs later than point P5, and point P10 occurs later than point P6. The fall of the pulse begins at point P11 and ends at point P12. Likewise, the rise of a pulse in signal OUT4 begins at point P13 and ends at point P14. Point P13 occurs later than point P9, and point P14 occurs later than point P10. The fall of the pulse begins at point P15 and ends at point P16.

The rise of a pulse in signal OUT5 begins at point P17 and ends at point P18. Point P17 occurs later than point P13, and point P18 occurs later than point P14. The fall of the pulse begins at point P19 and ends at point P20. Points P3, P7, P11,P15 and P19 all occur at the same time. Likewise, points P4, P8, P12, P16 and P20 all occur at the same time.

The signal resulting from a summation of OUT1, OUT2, OUT3, OUT4 and OUT5 has a rise that begins at point P21 and ends at point P22. Point P21 and point P1 occur at the same time. Likewise, point P22 and point P18 occur at the same time. Thus, the rise time in the summation signal is longer than the rise time of the input signals.

The summation signal has a fall that begins at point P23 and ends at point P24. Point P23 occurs at the same time as points P3, P7, P11, P15 and P19. Similarly, point P24 occurs at the same time as points P4, P8, P12, P16 and P20. Thus, the fall time of the summation signal is the same as the fall time for the input signals. As a result, the summation signal is an asymmetrical driver pulse in accordance with one embodiment of the invention.

Summing Amplifier

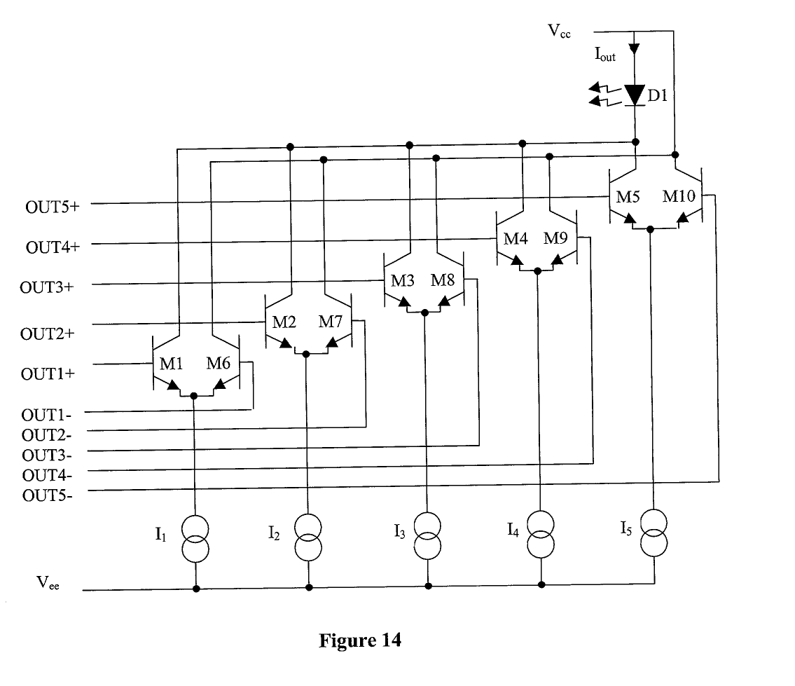

FIG. 14 illustrates a summing amplifier with five inputs in accordance with one embodiment of the present invention. Other embodiments have another number of inputs. More inputs result in more flexibility in adjusting the output waveform. Fewer inputs result in a lower circuit complexity. The positive supply voltage, V_{cc}, couples to the anode of laser diode D1 and the collectors of transistor M6, transistor M7, transistor M8, transistor M9 and transistor M10. The cathode of D1 couples to the collectors of transistor M1, transistor M2, transistor M3, transistor M4 and transistor M5. The output current, Iₒᵤₜ, is measured through laser diode D1.

OUT5+ couples to the base of transistor M5, and OUT4+ couples to the base of transistor M4. Similarly, OUT3+ couples to the base of transistor M3, and OUT2+ couples to the base of transistor M2. Likewise, OUT1+ couples to the base of transistor M1.

OUT1− couples to the base of transistor M6, and OUT2− couples to the base of transistor M7. Similarly, OUT3− couples to the base of transistor M8, and OUT4− couples to the base of transistor M9. Likewise, OUT5− couples to the base of transistor M10.

The negative supply voltage, Vₑₑ, couples to current generator I₁, current generator I₂, current generator I₃, current generator I₄ and current generator I₅. Current generator I₁ couples to the emitters of transistors M1 and M6. Likewise, current generator I₂ couples to the emitters of transistors M2 and M7. Similarly, current generator I₃ couples to the emitters of transistors M3 and M8. Likewise, current generator I₄ couples to the emitters of transistors M4 and M9. Finally, current generator I₅ couples to the emitters of transistors M5 and M10. In one embodiment, the current generators produce equal values. In other embodiments, each current generator is individually controllable, so the current generators may produce differing values.

Asymmetrical Driver Pulse

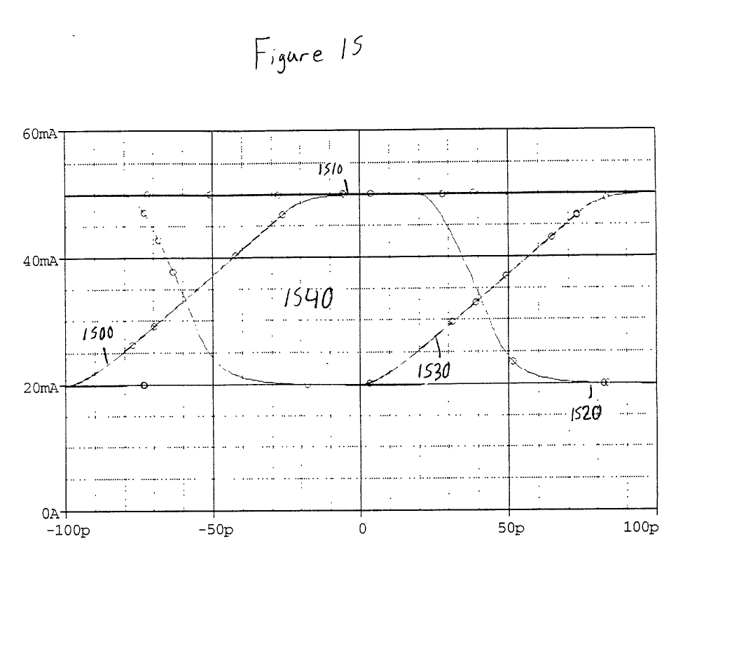

FIG. 15 illustrates an asymmetric driver pulse in accordance with one embodiment of the present invention. One pulse 1500 is initiated at time −100 ps, and the current rises to the high level of 50 mA 1510 more slowly than the current falls to a low level of 20 mA 1520 when the pulse is terminated at time 20 ps. Thus, the pulse width is 120 ps. A second pulse 1530 is generated 100 ps out of phase with the first pulse. As a result of the difference in rise and fall times, the eye 1540 of the driver pulse is asymmetrical.

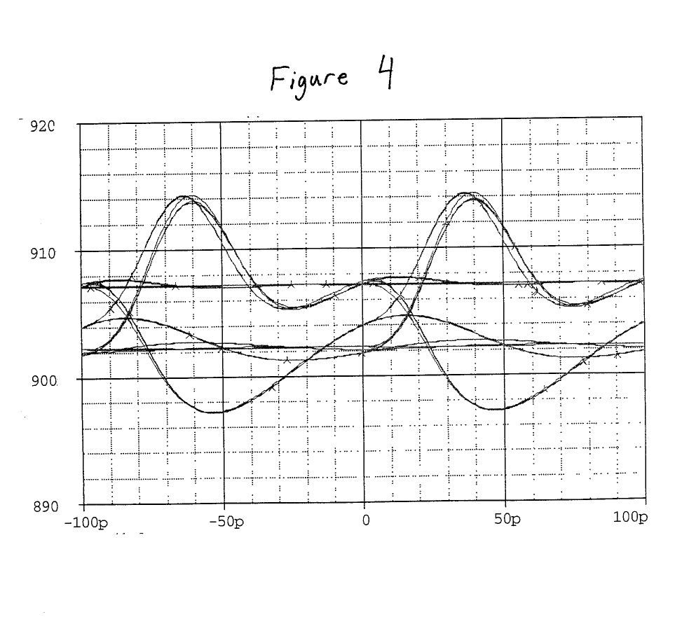

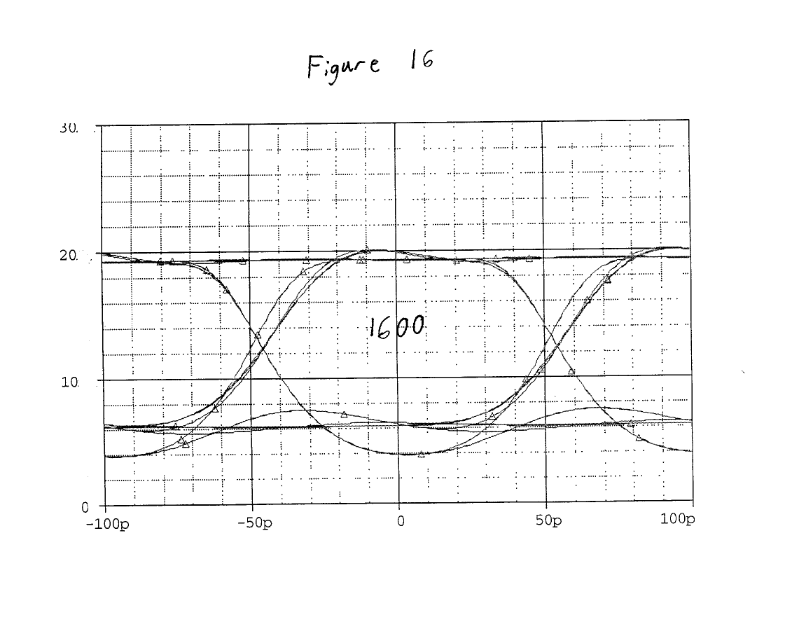

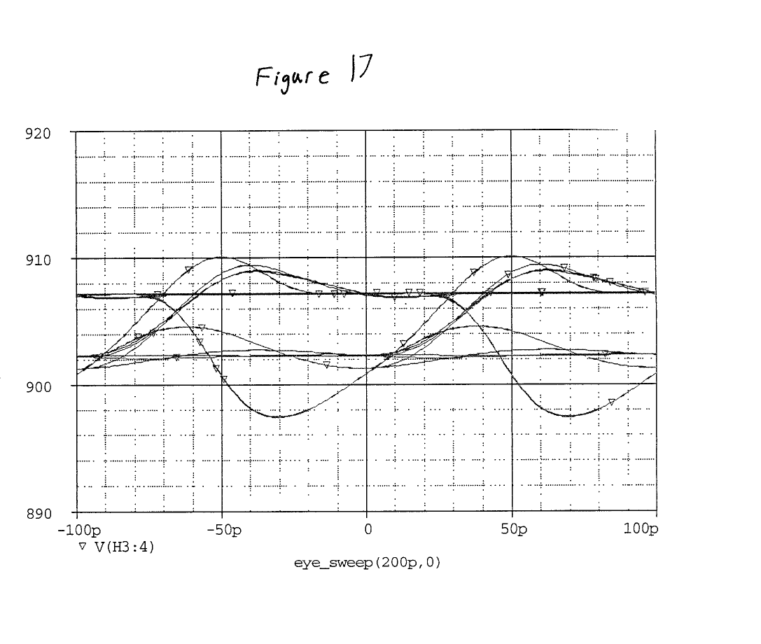

FIG. 16 illustrates the laser output given the asymmetric driver pulse of FIG. 15. The eye 1600 is symmetrical and not closed. FIG. 17 illustrates the chirp resulting form the driver pulse of FIG. 15. The chirp is reduced when compared to the chirp in FIG. 4. In FIG. 17, the peak-to-peak value is less than 13 units. Thus, the receiver sensitivity is not degraded and ringing is avoided.

Pulse Propagation Over Single Mode Optical Fiber

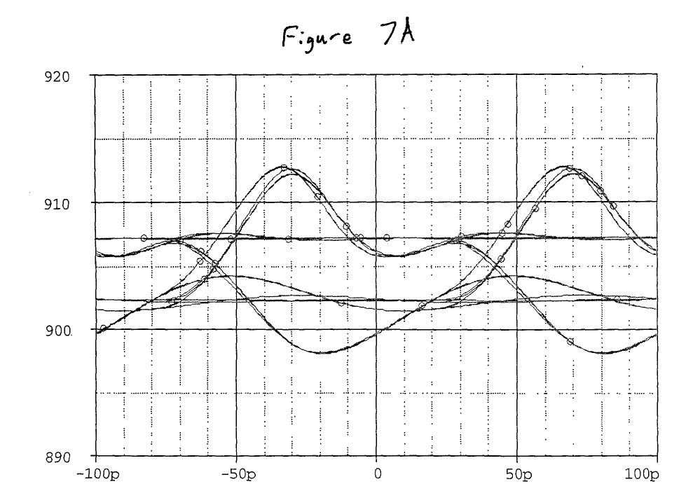

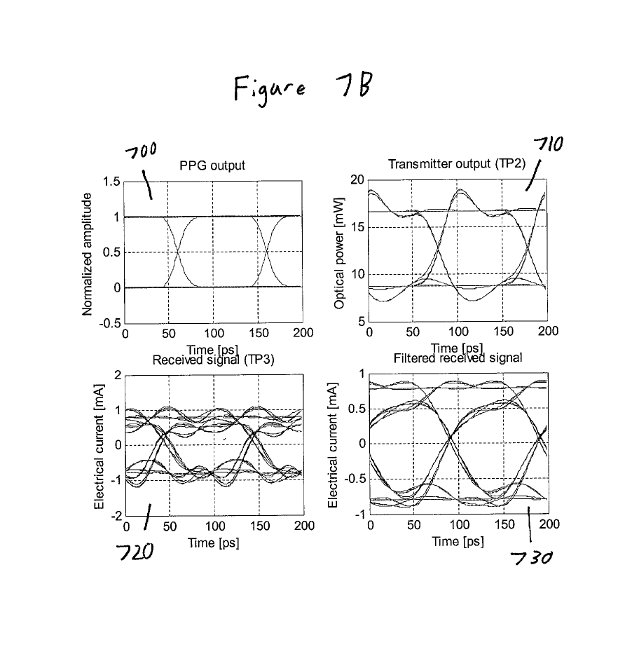

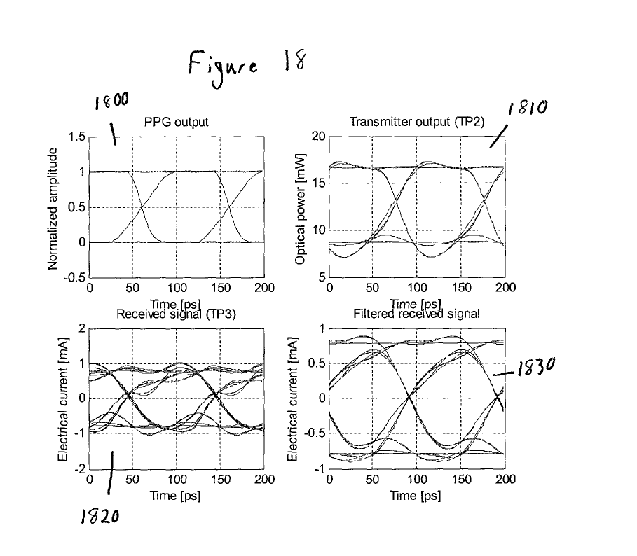

FIG. 18 illustrates pulse propagation over single mode optical fiber in accordance with one embodiment of the present application. The transmission speed is 10 Gbit/s. In pane 1 1800, an asymmetrical pulse is generated. Each pulse has a pulseshape with a linear slope for both the rising and falling edge. The fall time is 20 ps, and the rise time is 60 ps. The pulses are sent to a transmitter and the resulting signal is in pane 2 1810. The signal has a reduced overshoot when compared to the signal in pane 2 of FIG. 7B.

Pane 3 1820 shows the signals after they have propagated over a single mode optical fiber 40 km in length. At the end of the fiber, the signal reaches a receiver. The receiver is modeled as a PIN-diode receiver with a 7.5 GHz 4^{th} order Bessel filter. Pane 4 1830 shows the filtered signal.

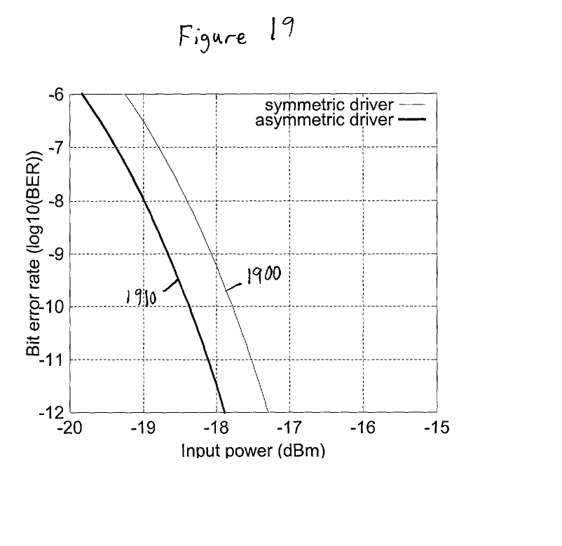

A common way of measuring the quality of a transmitter is to measure a bit error rate curve (BER-curve) for the transmitter after transmission over a relevant length of fiber. FIG. 19 illustrates the error associated with symmetric driver pulses and asymmetric driver pulses in accordance with one embodiment of the present invention. The BER curve for the symmetric driver of FIG. 7B 1900 and the BER-curve for the asymmetric driver of FIG. 18 1910 are plotted. The asymmetric driver gives a sensitivity gain of about 0.6 dB. Since penalties on the order of 1-2 dB are commonly accepted, a gain of 0.6 dB is a significant improvement.

Additional Illustrations

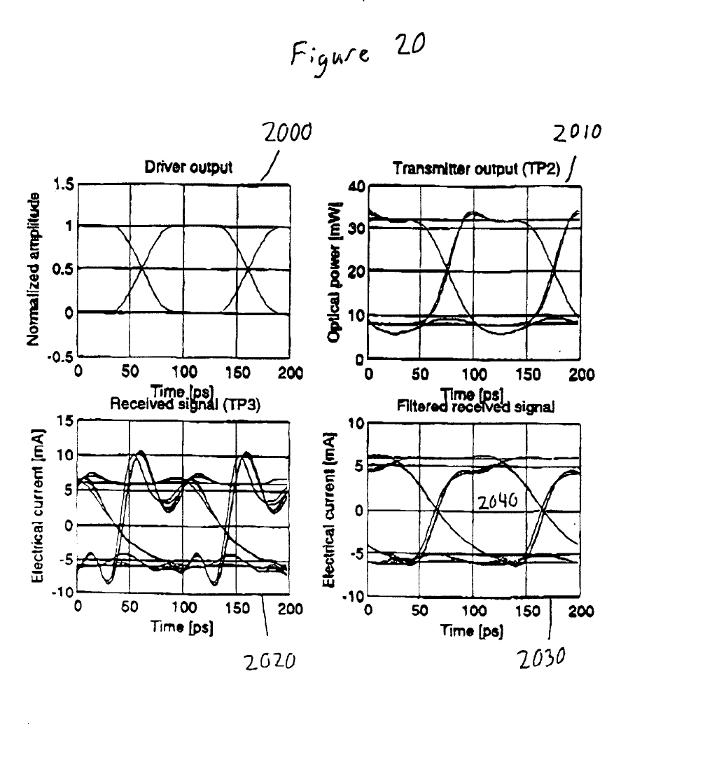

FIG. 20 illustrates driver output, transmitter output, received signal and filtered signal for a symmetrical driver. Pane 1 2000 is a symmetrical driver output. Pane 2 2010 is the output from the transmitter given the input from pane 1. Pane 3 2020 is the signal received at the receiver after the signal of pane 2 propagates through 20 km of fiber. Pane 4 2030 is the filtered signal achieved by filtering the received signal of pane 3 with a 7.5 GHz fourth order Bessel filter. The resulting eye 2040 is significantly distorted.

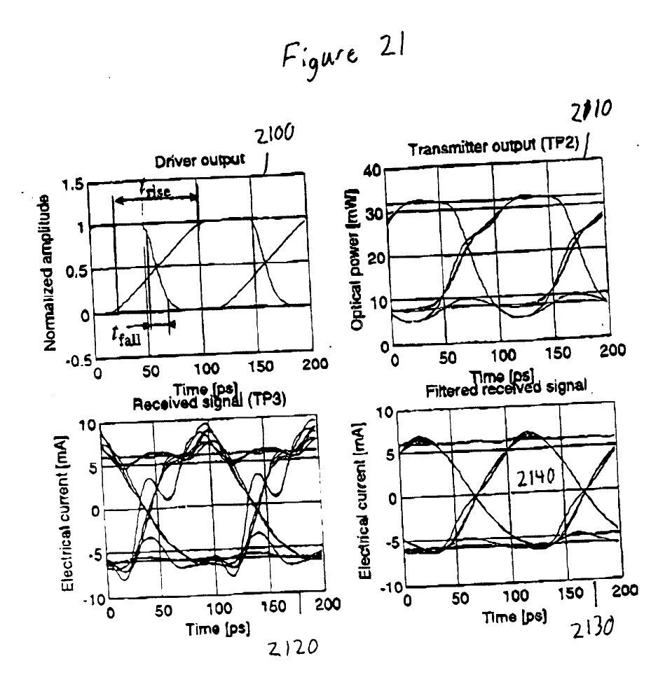

FIG. 21 illustrates driver output, transmitter output, received signal and filtered signal for a symmetrical driver in accordance with one embodiment of the present invention. Pane 1 2100 is an asymmetrical driver output. Pane 2 2110 is the output from the transmitter given the input from pane 1. Pane 3 2120 is the signal received at the receiver after the signal of pane 2 propagates through 20 km of fiber. Pane 4 2130 is the filtered signal achieved by filtering the received signal of pane 3 with a 7.5 GHz fourth order Bessel filter. The resulting eye 2140 is substantially more symmetric than the resulting eye 2040 in FIG. 20.

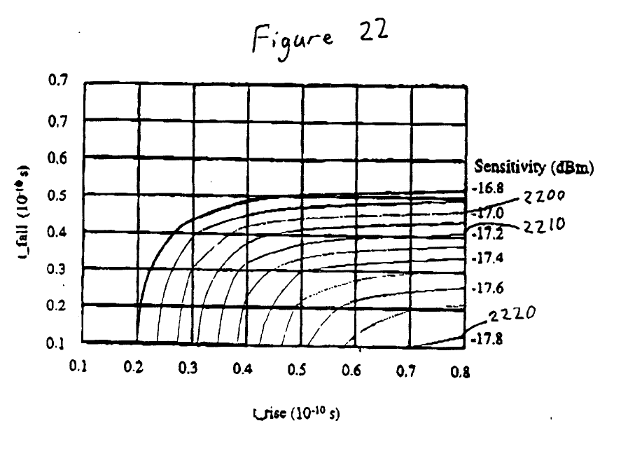

FIG. 22 illustrates contour plots in accordance with one embodiment of the present invention. The plots illustrate the sensitivity after pulses with varying rise and fall times are propagated through 20 km of fiber. A more negative sensitivity value is better. The best sensitivity value that can be achieved for a driver with a symmetric waveform (i.e., the rise time is equal to the fall time) is a sensitivity value of approximately −17.1 dBm when the rise time and fall time are both 40 ps. The grid point where rise and fall time are both 40 ps is approximately half way between the contour 2200 representing sensitivity of −17.0 dBm and the contour 2210 representing sensitivity of −17.2 dBm.

In contrast, a driver with an asymmetric waveform with a rise time of 70 ps and a fall time of 10 ps has a sensitivity value of approximately −17.8 dBm. The contour 2220 representing a sensitivity of −17.8 dBm approximately passes through the grid point where rise time is 70 ps and fall time is 10 ps. The difference in sensitivity of 0.7 dBm is significant as a total acceptable loss due to dispersion in typical links are typically 2 dBm.

Thus, a method and apparatus for ringing and inter-symbol interference reduction in optical communications is described in conjunction with one or more specific embodiments. The invention is defined by the following claims and their full scope and equivalents.

1. A method for ringing and inter-symbol interference reduction in an optical communications system comprising:
providing an asymmetric pulse having a rise time greater than a fall time.

2. The method of claim 1 wherein said rise time is substantially longer than said fall time.

3. The method of claim 2 wherein said rise time is at least 50% longer than said fall time.

4. The method of claim 2 wherein said rise time is at least twice the length of said fall time.

5. The method of claim 1 wherein said rise time is at least 30% of the pulse width.

6. The method of claim 1 further comprising:
increasing a pulse width of said pulse by delaying the beginning of the falling edge of said pulse.

7. The method of claim 1 wherein said pulse is sent to a direct modulated laser diode.

8. The method of claim 1 wherein said pulse is part of a high speed optical transmission.

9. An optical transmission system comprising:
a signal obtainer configured to obtain an input signal; and
a rise time increasing unit configured to increase a rise time for a pulse in said input signal wherein said rise time is greater than a fall time of said pulse.

10. The optical transmission system of claim 9 further comprising:
a pulse width increasing unit configured to increase a width of said pulse by delaying the beginning of the falling edge of said pulse.

11. The optical transmission system of claim 9 wherein said pulse is sent to a direct modulated laser diode.

12. The optical transmission system of claim 9 wherein said pulse is part of a high speed optical transmission.

13. The optical transmission system of claim 9 wherein said rise time for said pulse is substantially longer than a fall time of said pulse.

14. The optical transmission system of claim 13 wherein said rise time is at least fifty percent longer than said fall time.

15. The optical transmission system of claim 13 wherein said rise time is at least twice the length of said fall time.

16. The optical transmission system of claim 13 wherein said rise time is at least thirty percent of a bit period.

17. A computer program product comprising:
a computer usable medium having computer readable program code embodied therein configured to reduce ringing and inter-symbol interference, said computer program product comprising:
computer readable code configured to cause a computer to obtain an input signal; and
computer readable code configured to cause a computer to increase a rise time for a pulse in said input signal wherein said rise time is greater than a fall time of said pulse.

18. The computer program product of claim 17 further comprising:
computer readable code configured to cause a computer to increase a width of said pulse by delaying the beginning of the falling edge of said pulse.

19. The computer program product of claim 17 wherein said pulse is sent to a direct modulated laser diode.

20. The computer program product of claim 17 wherein said pulse is part of a high speed optical transmission.

21. The computer program product of claim 17 wherein said rise time for said pulse is substantally longer than said fall time of said pulse.

22. The computer program product of claim 21 wherein said rise time is at least fifty percent longer than said fall time.

23. The computer program product of claim 21 wherein said rise time is at least twice the length of said fall time.

24. The computer program product of claim 21 wherein said rise time is at least thirty percent of a bit period.
